(19) United States
(12) Patent Application Publication
(10) Pub. No.: US 2024/0300413 A1
(43) Pub. Date: Sep. 12, 2024

(54) DISPLAY DEVICE, CONTROL METHOD OF DISPLAY DEVICE, AND RECORDING MEDIUM

(71) Applicant: HONDA MOTOR CO., LTD., Tokyo (JP)

(72) Inventor: Takashi Noguchi, Tokyo (JP)

(21) Appl. No.: 18/436,473

(22) Filed: Feb. 8, 2024

(30) Foreign Application Priority Data
Mar. 6, 2023 (JP) 2023-033448

(51) Int. Cl. B60Q 9/00; G06F 3/14

(52) U.S. Cl. CPC B60Q 9/00; G06F 3/14

(57) ABSTRACT

An embodiment provides a display device including a display unit, a storage unit, a detection unit configured to detect an operation on the display device, and a display control unit configured to cause the display unit to display information, the display control unit being configured to not change information displayed by the display unit to information corresponding to the operation detected by the detection unit and to not cause the display unit to display attention calling information indicating attention calling regarding the operation when the detection unit detects the operation while the vehicle is driving.

### INCORPORATION BY REFERENCE

The present application claims priority under 35 U.S.C. § 119 to Japanese Patent Application No. 2023-033448 filed on Mar. 6, 2023. The content of the application is incorporated herein by reference in its entirety.

### BACKGROUND OF THE INVENTION

### Field of the Invention

The present invention relates to a display device, a control method of a display device, and a recording medium.

### Description of the Related Art

In recent years, active efforts have been made to provide sustainable access to transportation systems while taking into consideration even vulnerable people such as aged people, persons with disabilities, and children among traffic participants. To realize this, the focus is on research and development for further improving traffic safety and convenience through development regarding comfortability of vehicles. A technique for restricting an operation of a display device such as a navigation device provided in a vehicle while the vehicle is driving has been known as a technique related to comfortability of the vehicle (for example, see International Publication No. WO 2019/163060). International Publication No. WO 2019/163060 discloses an in-vehicle information device that, when a manual operation input is performed even in a case where restriction of manual operation input is in effect, displays a warning image indicating that manual operation input is restricted.

However, according to International Publication No. WO 2019/163060, when a driver of the vehicle sees a warning image in his/her peripheral vision, the driver can recognize that the image is being displayed, but cannot recognize that the image is a warning image. Therefore, according to International Publication No. WO 2019/163060, since the warning image is displayed, the driver of the vehicle may recognize erroneously that the in-vehicle information device has accepted an operation while the vehicle is driving.

The present invention has been made in view of the above-described circumstance, and an object thereof is to prevent the driver of the vehicle from recognizing erroneously that the display device has accepted an operation while the vehicle is driving.

### SUMMARY OF THE INVENTION

An aspect of the present invention provides a display device provided in a vehicle, the display device including: a display unit; a detection unit configured to detect an operation on the display device; and a display control unit configured to cause the display unit to display information, the display control unit being configured to not change information displayed by the display unit to information corresponding to the operation detected by the detection unit and to not cause the display unit to display attention calling information indicating attention calling regarding the operation when the detection unit detects the operation while the vehicle is driving.

### ADVANTAGEOUS EFFECT OF INVENTION

According to the aspect of the present invention, it is possible to prevent the driver of the vehicle from recognizing erroneously that the display device has accepted the operation while the vehicle is driving.

### BRIEF DESCRIPTION OF THE DRAWINGS

FIG. 1 is a diagram showing an example of a vehicle;

FIG. 2 is a diagram showing a configuration of the vehicle; and

FIG. 3 is a flowchart showing an operation of a display device.

### BRIEF DESCRIPTION OF THE DRAWINGS

### 1. Configuration of Vehicle

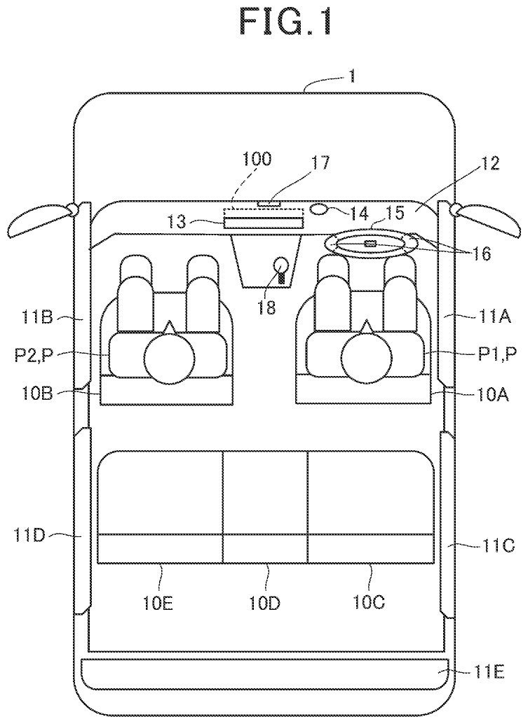

FIG. 1 is a diagram showing an example of a vehicle 1.

The vehicle 1 illustrated in FIG. 1 is a four-wheel vehicle with a riding capacity of five persons. The vehicle 1 includes a driver seat 10A, a passenger seat 10B, a right rear seat 10C, a center rear seat 10D, and a left rear seat 10E. In the vehicle 1 shown in FIG. 1, a driver P1 and a fellow passenger P2 are riding as occupants P of the vehicle 1. In the vehicle 1 shown in FIG. 1, a situation is shown in which the driver P1 is seated in the driver seat 10A, and a situation is shown in which the fellow passenger P2 is seated in the passenger seat 10B. The vehicle 1 is not limited to a four-wheel vehicle, and may have three or less wheels or five or more wheels. In addition, the riding capacity of the vehicle 1 is not limited to five persons.

The vehicle 1 includes a right front door 11A, a left front door 11B, a right rear door 11C, a left rear door 11D, and a tailgate 11E. By opening of the right front door 11A, the left front door 11B, the right rear door 11C, and the left rear door 11D, passengers can enter or exit an interior space of the vehicle 1. The tailgate 11E opens and closes a trunk of the vehicle 1.

The vehicle 1 includes a dashboard 12. The dashboard 12 is installed with a touch panel 13 and a speaker 14. The touch panel 13 is configured in such a manner that a display panel and a touch sensor are overlapped or integrated, the display panel being configured to display characters and images, a touch sensor being configured to detect contact with the display panel. The speaker 14 outputs a voice to the interior space of the vehicle 1. The installation positions and numbers of the speaker 14 can be changed as desired.

The touch panel 13 is an example of a “display unit”.

A steering wheel 15 is installed on the dashboard 12. A steering wheel grip sensor 16 is arranged on the steering wheel 15. The steering wheel grip sensor 16 is realized by a capacitive sensor, and detects whether the driver P1 is gripping the steering wheel 15 with both hands.

A camera 17 is installed inside the interior of the vehicle 1 to capture the interior of the vehicle 1. The camera 17 is a so-called driver monitoring camera (DMC), and captures the driver P1 seated in the driver seat 10A. A capturing range of the camera 17 is set to a range including the head of the driver P1. The capturing range of the camera 17 may be set to a range in which the occupant P other than the driver P1 can be captured.

In the interior of the vehicle 1, a shift lever 18 is installed near the driver seat 10A.

The vehicle 1 includes a display device 100. The display device 100 includes a touch panel 13, and is configured as a device called display audio (DA) or a car navigation device, for example.

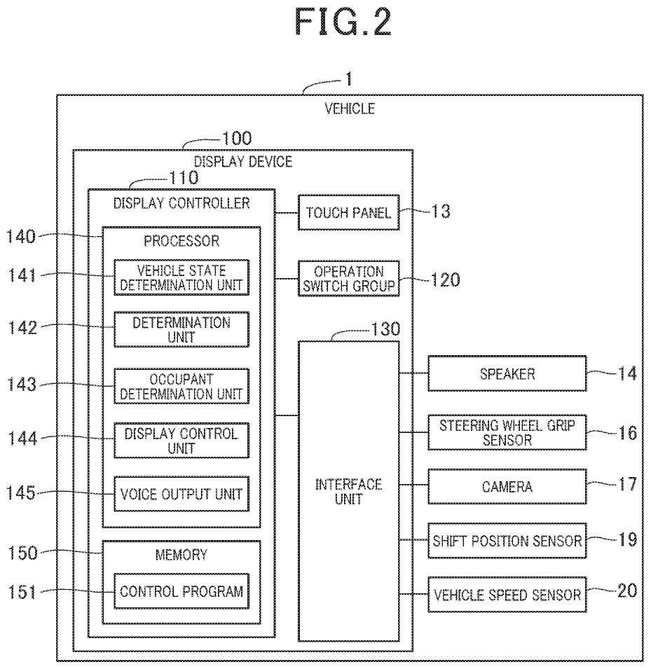

FIG. 2 is a diagram showing the configuration of the vehicle 1.

The vehicle 1 includes a display device 100, a speaker 14, a steering wheel grip sensor 16, a camera 17, a shift position sensor 19, and a vehicle speed sensor 20. The display device 100 is connected with the speaker 14, the steering wheel grip sensor 16, the camera 17, the shift position sensor 19, and the vehicle speed sensor 20. The devices connected to the display device 100 are not limited to these devices, and other devices may be connected.

The speaker 14 outputs various voices according to control of the display device 100.

The steering wheel grip sensor 16 detects whether the driver P1 is gripping the steering wheel 15 with both hands at a predetermined period, and outputs a detection signal to the display device 100 whenever detection.

The camera 17 outputs image data of the captured image to the display device 100.

The shift position sensor 19 detects shift positions of the shift lever 18 provided in the vehicle 1. The shift positions include, for example, P (parking) used during parking or stopping, R (reverse) used during revering, N (neutral), and D (drive) used during driving. The shift position sensor 19 outputs a detection signal indicating the detected shift position to the display device 100.

The vehicle speed sensor 20 detects a speed of the vehicle 1. The vehicle speed sensor 20 detects a speed of the vehicle 1 at a predetermined period, and outputs a detection signal indicating the speed of the vehicle 1 detected every detection to the display device 100.

The display device 100 is a device provided in the vehicle 1. The display device 100 may function as a vehicle controller that controls each unit of the vehicle 1.

The display device 100 includes a display controller 110, a touch panel 13, an operation switch group 120, and an interface unit 130.

The display controller 110 incudes a processor 140 such as a CPU (Central Processing Unit) or an MPU (Micro Processor Unit), a memory 150, and an interface circuit configured to connect other devices and sensors, and controls each of the units of the display device 100.

The memory 150 is an example of a “storage unit”.

The memory 150 is a storage device that stores programs and data. The memory 150 stores data processed by a control program 151 and the processor 140. The memory 150 has a nonvolatile storage region. Further, the memory 150 may have a volatile region and constitute a work area of the processor 140. The memory 150 is configured by a ROM (Read Only Memory) or a RAM (Random Access Memory), for example.

The control program 151 is an example of a “program”.

The touch panel 13 displays various kinds of information according to control of the display controller 110. The touch panel 13 outputs a detection signal of a touch sensor to the display controller 110.

The operation switch group 120 includes various operation switches for operating the display device 100. Each of the operation switches in the operation switch group 120 outputs an operation signal to the display controller 110 when being operated.

The interface unit 130 includes hardware such as a connector and a communication circuit, and communicates with various devices that communicatively connected to the display device 100. In the present embodiment, the interface unit 130 is communicatively connected to the speaker 14, the steering wheel grip sensor 16, the camera 17, the shift position sensor 19, and the vehicle speed sensor 20.

The processor 140 reads and executes the control program 151 stored in the memory 150, and thus functions as a vehicle state determination unit 141, a detection unit 142, an occupant determination unit 143, a display control unit 144, and a voice output unit 145.

The occupant determination unit 143 is an example of a “determination unit”.

The vehicle state determination unit 141 determines a state of the vehicle 1.

The vehicle state determination unit 141 determines whether the vehicle 1 is driving. The vehicle state determination unit 141 determines that the vehicle 1 is driving when the detection signal output by the vehicle speed sensor 20 indicates a speed greater than 0 km/h.

The vehicle state determination unit 141 determines whether the vehicle 1 is in a specific state. The specific state is a state in which the speed of the vehicle 1 is equal to or less than a predetermined value, and more specifically, a state in which the speed of the vehicle 1 is zero for a predetermined period of time. In other words, the specific state is a state in which the vehicle 1 stops or is parking. The vehicle state determination unit 141 determines that the state of the vehicle 1 is the specific state when the speed indicated by the detection signal from the vehicle speed sensor 20 does not change for a predetermined period of time after the detection signal of the vehicle speed sensor 20 indicates 0 km/h. The vehicle state determination unit 141 may determine that the vehicle 1 is in the specific state when the detection signal from the shift position sensor 19 indicates a shift position of P (parking).

The detection unit 142 detects an operation on the display device 100 (hereinafter, referred to as a “device operation”). The detection unit 142 detects that there is the device operation when the detection signal of the touch sensor is input from the touch panel 13. Further, the detection unit 142 detects that there is the device operation when an operation signal is input from the operation switch group 120. Examples of the device operation may include an operation for switching the screen displayed by the touch panel 13 and an operation for inputting a destination.

The detection unit 142 specifies operation contents of the detected device operation. The detection unit 142 specifies operation contents of the device operation through the touch panel 13 based on a correspondence between a touch position indicated by the detection signal of the touch sensor and an icon displayed on the display panel of the touch panel 13. In addition, the detection unit 142 specifies operation contents of the device operation through the operation switch based on the type of the operation signal output from the operation switch group 120.

When detecting the device operation, the detection unit 142 outputs the fact that the device operation is detected to the display control unit 144 and the voice output unit 145 whenever the device operation is detected. Further, when detecting the device operation, the detection unit 142 specifies the operation contents of the detected device operation whenever the device operation is detected, and outputs the specified operation contents to the display control unit 144.

The occupant determination unit 143 determines whether the occupant P, who performs the device operation detected by the detection unit 142, is the driver P1.

For example, the occupant determination unit 143 determines whether the occupant P, who performs the device operation, is the driver P1, based on a detection signal of the steering wheel grip sensor 16 that is output after a timing at which the detection unit 142 detects the device operation and at a timing closest to the timing described above. In other words, when the detection signal of the steering wheel grip sensor 16 indicates that the driver P1 is gripping the steering wheel 15 with both hands, the occupant determination unit 143 determines that the occupant P, who performs the device operation, is not the driver P1. On the other hand, when the detection signal of the steering wheel grip sensor 16 indicates that the driver P1 is not gripping the steering wheel 15 with both hands, the occupant determination unit 143 determines that the occupant P, who performs the device operation, is the driver P1.

For example, the occupant determination unit 143 determines whether the occupant P, who performs the device operation, is the driver P1, based on a captured image captured by the camera 17 after a timing at which the detection unit 142 detects the device operation and at a timing closest to the timing described above. In other words, the occupant determination unit 143 specifies an orientation of a face of the driver P1 appearing in the captured image of the camera 17 by pattern matching, and determines that the occupant P, who performs the device operation, is not the driver P1 when the specified orientation of the face is not directed toward the touch panel 13. On the other hand, the occupant determination unit 143 determines that the occupant P, who performs the device operation, is the driver P1 when the specified orientation of the face is directed toward the touch panel 13. The correspondence between the orientation of the face in the captured image and whether the face is directed to the touch panel 13 is determined in advance through prior tests, simulations, and the like.

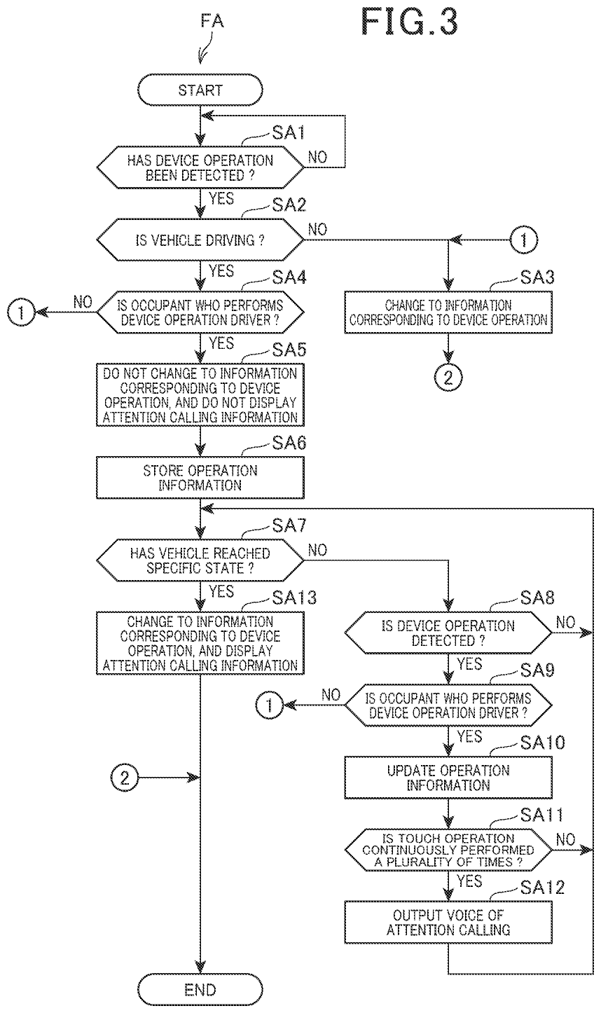

The display control unit 144 causes the touch panel 13 to display information. An operation of the display control unit 144 will be described in detail with reference to FIG. 3.

The voice output unit 145 outputs a voice through the speaker 14. An operation of the voice output unit 145 will be described in detail with reference to FIG. 3.

### 2. Operation of Display Device

Next, an operation of the display device 100 will be described.

FIG. 3 is a flowchart FA showing an operation of the display device 100.

The display control unit 144 determines whether the detection unit 142 has detected the device operation (step SA1).

When determining that the detection unit 142 has not detected the device operation (step SA1: NO), the display control unit 144 performs the determination in step SA1 again.

On the other hand, when the display control unit 144 determines that the detection unit 142 has detected the device operation (step SA1: YES), the vehicle state determination unit 141 determines whether the vehicle 1 is driving (step SA2).

When the vehicle state determination unit 141 determines whether the vehicle 1 is not driving (step SA2: NO), the display control unit 144 changes the information displayed by the touch panel 13 to information corresponding to the device operation detected by the detection unit 142 (step SA3).

On the other hand, when the vehicle state determination unit 141 determines whether the vehicle 1 is driving (step SA2: YES), the occupant determination unit 143 determines whether the occupant P who performs the device operation is the driver P1 (step SA4).

When the occupant determination unit 143 determines that the occupant P who performs the device operation is not the driver P1 (step SA4: NO), the display control unit 144 changes the information displayed by the touch panel 13 to information corresponding to the device operation detected by the detection unit 142 (step SA3).

On the other hand, when the occupant determination unit 143 determines that the occupant P who performs the device operation is the driver P1 (step SA4: YES), the display control unit 144 does not change information displayed by the touch panel 13 to information corresponding to the device operation detected by the detection unit 142 and does not display attention calling information (step SA5). The attention calling information is information indicating attention calling regarding the device operation, and more specifically, information indicating attention calling that the display device 100 cannot be operated while the vehicle 1 is driving. The attention calling information is, for example, information having a character string such as “operation is not possible”.

Next, the display control unit 144 causes the memory 150 to store the operation information (step SA6). The operation information is information indicating the device operation detected by the detection unit 142, where operation contents of the device operation specified by the detection unit 142 are recorded.

Next, the vehicle state determination unit 141 determines whether the state of the vehicle 1 has reached a specific state (step SA7).

When the vehicle state determination unit 141 determines that the vehicle 1 is not in the specific state (step SA7: NO), the display control unit 144 determines whether the detection unit 142 has detected the device operation (step SA8).

When the display control unit 144 determines that the detection unit 142 has not detected the device operation (step SA8: NO), the process returns to step SA7, and the processor 140 performs step SA7 and subsequent processes again.

When the display control unit 144 determines that the detection unit 142 has detected the device operation (step SA8: YES), the occupant determination unit 143 determines whether the occupant P who performs the device operation is the driver P1 (step SA9).

When the occupant determination unit 143 determines that the occupant P who performs the device operation is not the driver P1 (step SA9: NO), the display control unit 144 changes the information displayed by the touch panel 13 to information corresponding to the device operation most recently detected by the detection unit 142 (step SA3).

On the other hand, when the occupant determination unit 143 determines that the occupant P who performs the device operation is the driver P1 (step SA9: YES), the display control unit 144 updates the operation information stored in the memory 150 to operation information indicating the device operation most recently detected by the detection unit 142 (step SA10).

Next, the voice output unit 145 determines whether the detection unit 142 has continuously detected the device operation a plurality of times (step SA11). When determining that the detection unit 142 has continuously detected the device operation for N (N being an integer of 2 or more) or more times within a predetermined period (for example, 5 seconds), the voice output unit 145 makes an affirmative determination in step SA11.

When the voice output unit 145 determines that the detection unit 142 has not continuously detected the device operation a plurality of times (step SA11: NO), the process returns to step SA7, and the processor 140 performs step SA7 and subsequent processes again.

On the other hand, when determining that the detection unit 142 has continuously detected the device operation a plurality of times (step SA11: YES), the voice output unit 145 outputs a voice of attention calling regarding the device operation from the speaker 14 (step SA12). An example of the voice is a voice indicating attention calling such as “operation is not possible” that the operation of the display device 100 is not possible.

Returning to the description of step SA7, when the vehicle state determination unit 141 determines that the vehicle 1 is in the specific state (step SA7: YES), the display control unit 144 updates the information displayed by the touch panel 13 to the information corresponding to the device operation indicated by the operation information stored in the memory 150, and displays attention calling information (step SA13).

The attention calling information displayed in step SA13 is preferably not displayed when a predetermined period of time has passed since the display starts. Thereby, it is possible to prevent the occupant P from feeling troublesomeness by the attention calling information being displayed for a long period of time.

### 3. Other Embodiments

The above-described embodiments are merely examples of one aspect of the present invention, and can be arbitrarily modified and applicable.

The above-described embodiment has the configuration in which the attention calling information is displayed when the vehicle 1 reaches a specific state, but other embodiments may have a configuration in which the attention calling information is not displayed when the vehicle 1 reaches a specific state.

In the above-described embodiment, the specific state is a state in which the speed of the vehicle 1 is zero for a predetermined period of time. In other embodiments, the specific state may be a state in which the speed of the vehicle 1 is equal to or less than a predetermined value. An example of the predetermined value may be 5 km/h. In other embodiments, the vehicle state determination unit 141 determines that the vehicle 1 is driving when the speed of the vehicle 1 is greater than the predetermined value.

The touch panel 13 is exemplified as the “display unit” in the above-described embodiment, but the “display unit” may be a display not including a touch sensor.

The processor 140 may be configured by a single processor or may be configured by a plurality of processors. The processor 140 may be hardware programmed to realize the corresponding functional units. In other words, the processor 140 may be configured by, for example, an application specific integrated circuit (ASIC) or a field programmable gate array (FPGA).

Further, the configuration of the vehicle 1 shown in FIG. 2 is an example, and a specific implementation form is not particularly limited. In other words, hardware individually corresponding to each of the components may not necessarily be implemented, but it is apparently possible to realize functions of each of the components by executing programs by one processor. Further, a part of the functions realized by software in the aforementioned embodiment may be hardware, or a part of the functions realized by hardware may be realized by software. Additionally, a specific detail configuration of each of the components of the vehicle 1 can be arbitrarily changed.

The operation step units shown in FIG. 3 are divided depending on main process contents in order to facilitate understanding of the operation, and the present invention is not limited by a division method or a name of the process units. The operation step units may be divided into more step units depending on the process contents. In addition, one step unit may be divided so as to include more processes. The order of the steps may be changed as appropriate without departing from the spirit and scope of the present invention.

Further, in the case of realizing a control method of the display device 100 described above using the processor 140, it is also possible to implement the program to be executed by the processor 140 in the form of a recording medium or a transmission medium which transmits the program. In other words, the control program 151 can be realized in the state of recording the control program 151 in a portable information recording medium. Examples of the information recording medium are a magnetic recording medium such as a hard disk, an optical recording medium such as a CD, and a semiconductor storage device such as a USB (Universal Serial Bus) memory and an SSD (Solid State Drive), and the other recording medium can be also used.

### 4. Configurations Supported by Embodiment Described Above

The above-described embodiment supports the following configurations.

(Configuration 1) A display device provided in a vehicle, the display device including: a display unit; a detection unit configured to detect an operation on the display device; and a display control unit configured to cause the display unit to display information, the display control unit being configured to not change information displayed by the display unit to information corresponding to the operation detected by the detection unit and to not cause the display unit to display attention calling information indicating attention calling regarding the operation when the detection unit detects the operation while the vehicle is driving.

According to the display device of Configuration 1, the display contents of the display unit do not change due to the operation on the display device. For this reason, it is possible to prevent the driver from recognizing erroneously that the display device has accepted an operation while the vehicle is driving.

(Configuration 2) In the display device according to Configuration 1, the display device further includes a storage unit, the display control unit is configured to cause the storage unit to store operation information indicating the operation detected by the detection unit when the detection unit detects the operation while the vehicle is driving, and the display control unit is configured to change information displayed by the display unit to the information corresponding to the operation indicated by the operation information stored in the storage unit when the vehicle reaches a specific state after the operation information is stored in the storage unit.

According to the display device of Configuration 2, when the vehicle reaches the specific state, the information displayed by the display unit is changed to the information corresponding to the operation. For this reason, it is possible to change to the information desired by the operator while preventing the driver of the vehicle from recognizing erroneously that the display device has accepted the operation at the time of the driving of the vehicle.

(Configuration 3) In the display device according to Configuration 2, the specific state is a state in which a speed of the vehicle is equal to or less than a predetermined value.

According to the display device of Configuration 3, since the information displayed by the display unit is changed in the state in which the speed of the vehicle is equal to or less than the predetermined value, it is possible to change the displayed information in situations where there is a high probability that the driver can confirm safety.

(Configuration 4) In the display device according to Configuration 3, the specific state is a state in which the speed of the vehicle is zero for a predetermined period of time.

According to the display device of Configuration 4, since the information displayed by the display device is changed in the state in which a speed of the vehicle is zero for the predetermined period of time, it is possible to prevent the driver from being distracted by something other than driving, that is, from looking aside while driving.

(Configuration 5) In the display device according to any one of Configurations 1 to 4, the display device further includes a voice output unit configured to output a voice of attention calling regarding the operation when the detection unit continuously detects the operation a plurality of times while the vehicle is driving.

According to the display device of Configuration 5, when the display device is continuously operated a plurality of times while the vehicle is driving, a voice of attention calling regarding the operation is output, and thus it is possible to allow the driver of the vehicle to grasp that the operation on the display device is a target of the attention calling at the time of driving of the vehicle, without looking at the display device, while preventing unnecessary attention calling. Therefore, it is possible to prevent the driver from looking aside while driving, while preventing the driver of the vehicle from feeling uncomfortable due to the unnecessary attention calling.

(Configuration 6) In the display device according to any one of Configurations 2 to 5, the display device further includes a determination unit configured to determine whether an occupant of the vehicle who performs the operation is a driver, when the determination unit determines that the occupant who performs the operation is the driver, the display control unit is configured to not change information displayed by the display unit until the vehicle reaches the specific state, and when the determination unit determines that the occupant who performs the operation is not the driver, the display control unit is configured to change information displayed by the display unit to information corresponding to the operation detected by the detection unit even when the vehicle does not reach the specific state.

According to the display device of Configuration 6, when the occupant who performs the operation on the display device is a fellow passenger other than the driver, it is possible to change information displayed by the display device to information corresponding to the operation even while the vehicle is driving, and thus it is possible to improve convenience for the occupant of the vehicle.

(Configuration 7) In the display device according to Configuration 6, the determination unit determines whether a steering wheel installed in the vehicle is gripped, or whether the occupant of the vehicle who performs the operation is the driver, based on an image captured by a camera that captures an interior of the vehicle.

According to the display device of Configuration 7, since it can be accurately determined whether the occupant who performs the operation on the display device is the driver, it is possible to reduce occurrence of situations where information on the display unit is not changed even though the fellow passenger is operating the display device. Therefore, the convenience for the occupant can be further improved.

(Configuration 8) In the display device according to any one of Configurations 2 to 7, the display control unit updates the operation information stored in the storage unit whenever the detection unit detects the operation while the vehicle is driving.

According to the display device of Configuration 8, when the vehicle reaches the specific state, information displayed by the display unit can be changed to information corresponding to an operation most recently detected. Therefore, when the vehicle reaches the specific state, the operator of the display device can change to information most recently desired, and the convenience for the occupant can be improved.

(Configuration 9) In the display device according to any one of Configurations 2 to 8, the display control unit changes information displayed by the display unit and causes the display unit to display the attention calling information when the vehicle reaches the specific state.

According to the display device of Configuration 9, when information displayed by the display unit is changed, the driver of the vehicle can recognize that the operation on the display device while the vehicle is driving is a target of the attention calling. Therefore, it is possible to prevent the driver from looking aside while driving.

(Configuration 10) A control method of a display device provided in a vehicle, the method including: when an operation on the display device is detected while the vehicle is driving, not changing information to be displayed to information corresponding to the detected operation and not displaying attention calling information indicating attention calling regarding the operation.

According to the control method of a display device of Configuration 10, the same effect as in the display device of Configuration 1 is achieved.

(Configuration 11) A non-transitory computer readable recording medium recording a program causing a processor of a display device provided in a vehicle and including a display unit to function as: a detection unit configured to detect an operation on the display device; and a display control unit configured to cause the display unit to display information, the display control unit being configured to not change information displayed by the display unit to information corresponding to the operation detected by the detection unit and to not cause the display unit to display attention calling information indicating attention calling regarding the operation when the detection unit detects the operation while the vehicle is driving.

According to the recording medium of Configuration 11, the same effect as in the display device of Configuration 1 is achieved.

### REFERENCE SIGNS LIST

1 vehicle
13 touch panel (display unit)
14 speaker
15 steering wheel
16 steering wheel grip sensor
17 camera
18 shift lever
19 shift position sensor
20 vehicle speed sensor
100 display device
110 display controller
120 operation switch group
130 interface unit
140 processor
141 vehicle state determination unit
142 detection unit
143 occupant determination unit (determination unit)
144 display control unit
145 voice output unit
150 memory (storage unit)
151 control program (program)
P occupant
P1 driver
P2 fellow passenger

What is claimed is:

1. A display device provided in a vehicle, the display device comprising:
a display unit;
a detection unit configured to detect an operation on the display device; and
a display control unit configured to cause the display unit to display information,
the display control unit being configured to not change information displayed by the display unit to information corresponding to the operation detected by the detection unit and to not cause the display unit to display attention calling information indicating attention calling regarding the operation when the detection unit detects the operation while the vehicle is driving.

2. The display device according to claim 1, further comprising
a storage unit, wherein
the display control unit is configured to cause the storage unit to store operation information indicating the operation detected by the detection unit when the detection unit detects the operation while the vehicle is driving, and
the display control unit is configured to change information displayed by the display unit to the information corresponding to the operation indicated by the operation information stored in the storage unit when the vehicle reaches a specific state after the operation information is stored in the storage unit.

3. The display device according to claim 2, wherein
the specific state is a state in which a speed of the vehicle is equal to or less than a predetermined value.

4. The display device according to claim 3, wherein
the specific state is a state in which the speed of the vehicle is zero for a predetermined period of time.

5. The display device according to claim 1, further comprising
a voice output unit configured to output a voice of attention calling regarding the operation when the detection unit continuously detects the operation a plurality of times while the vehicle is driving.

6. The display device according to claim 2, further comprising
a determination unit configured to determine whether an occupant of the vehicle who performs the operation is a driver, wherein
when the determination unit determines that the occupant who performs the operation is the driver, the display control unit is configured to not change information displayed by the display unit until the vehicle reaches the specific state, and
when the determination unit determines that the occupant who performs the operation is not the driver, the display control unit is configured to change information displayed by the display unit to information corresponding to the operation detected by the detection unit even when the vehicle does not reach the specific state.

7. The display device according to claim 6, wherein
the determination unit determines whether a steering wheel installed in the vehicle is gripped, or whether the occupant of the vehicle who performs the operation is the driver, based on an image captured by a camera that captures an interior of the vehicle.

8. The display device according to claim 2, wherein
the display control unit updates the operation information stored in the storage unit whenever the detection unit detects the operation while the vehicle is driving.

9. The display device according to claim 2, wherein
the display control unit changes information displayed by the display unit and causes the display unit to display the attention calling information when the vehicle reaches the specific state.

10. A control method of a display device provided in a vehicle, the method comprising:
when an operation on the display device is detected while the vehicle is driving, not changing information to be displayed to information corresponding to the detected operation and not displaying attention calling information indicating attention calling regarding the operation.

11. A non-transitory computer readable recording medium recording a program causing a processor of a display device provided in a vehicle and including a display unit to function as:
a detection unit configured to detect an operation on the display device; and
a display control unit configured to cause the display unit to display information,
the display control unit being configured to not change information displayed by the display unit to information corresponding to the operation detected by the detection unit and to not cause the display unit to display attention calling information indicating attention calling regarding the operation when the detection unit detects the operation while the vehicle is driving.
